(19) United States
(12) Patent Application Publication
(10) Pub. No.: US 2023/0141210 A1
(43) Pub. Date: May 11, 2023

(54) NEURAL NETWORKS

(71) Applicant: Hewlett-Packard Development Company, L.P., Spring, TX (US)

(72) Inventors: Pierre Belgarric, Bristol (GB); Christopher Ian Dalton, Bristol (GB); Adrian John Baldwin, Bristol (GB)

(73) Assignee: Hewlett-Packard Development Company, L.P., Spring, TX (US)

(21) Appl. No.: 17/913,606

(22) PCT Filed: Apr. 10, 2020
(86) PCT No.: PCT/US2020/027630

§ 371 Date: Sep. 22, 2022

(51) Int. Cl. G06N 3/04; H04L 9/32

(52) U.S. Cl. CPC G06N 3/04; H04L 9/32

(57) ABSTRACT

The present disclosure relates to a neural network. The neural network may comprise a first portion, comprising a plurality of layers of the neural network, to perform a first cryptographic operation on input data. The neural network may further comprise a second portion, comprising a plurality of layers of the neural network, to perform processing on the data. The neural network may further comprise a third portion, comprising a plurality of layers of the neural network, to perform a second cryptographic operation on the processed data.

### BACKGROUND

Machine learning has been identified as a powerful technique for providing automated solutions to complex fact or information-based tasks that would otherwise be very time-intensive to complete. Machine learning may be implemented on a neural network. There are several different architectures that may be employed to build neural networks; the more complex architectures falling under the scope of so-called “deep learning”. Neural networks may comprise multiple “layers”. Such layers may be made up of a single node or a plurality of nodes. The nodes may be a collection of interconnected processing units. Nodes may also be referred to as neurons.

Cryptography is a useful technique for protecting sensitive data. Many cryptographic techniques involve receiving an input and converting the input into an “encrypted” output, wherein the all or most patterns linking the input to the output may be removed. Data or information in an encrypted format may be referred to as ciphertext, ciphertext data or encrypted data. Unencrypted data or information may be referred to as plain text, plaintext, cleartext, unencrypted data or decrypted data. Encryption may be seen as an operation that encodes information in a format that is intelligible to authorized parties and not to non-authorized parties. The encryption function ‘Enc’ may be associated to a decryption function ‘Dec’ so that for any message ‘m’, Dec(keyᵢ Enc(keyᵢ m))=m. As well as encryption other similar cryptographic operations may make different guarantees. For example a message authentication code (MAC) may guarantee the integrity of a message—that is the message is exclusively changeable by someone who holds a given key. This may be implemented using a hash function and may then be referred to as an HMAC.

### BRIEF DESCRIPTION OF DRAWINGS

Non-limiting examples will now be described with reference to the accompanying drawings, in which:

FIGS. 1a and 1b are simplified schematics of a device according to some examples;

FIG. 2 is a simplified schematic of a neural network or part of a neural network for performing functions according to AES;

FIGS. 3a and 3b are other simplified schematics of a device according to some examples;

FIGS. 4a and 4b are other simplified schematics of a device according to some examples;

FIG. 5 is a flowchart of a method according to some examples; and

FIG. 6 is another flowchart of a method according to some examples.

### DETAILED DESCRIPTION

Neural network may be used to perform tasks such as image detection/recognition, path planning and resource optimisation with improved efficiency.

The structure of a neural network may be derived from a so-called multi-layer perceptron architecture (MLP), which features an input layer (or region), a processing layer, and an output layer. The input layer of the network may improve the compatibility of, and discretise all data passing to the processing layer. In practice there may be a plurality of processing layers. A processing layer may use functions, such as activation functions, to perform transformations or other processing on the discretised data. The output layer may amalgamate the transformed discretised data into one output representing the overall transformation to the input data.

Due to the potential of this technology, it may be of interest to implement machine learning on otherwise sensitive data, which may risk the disclosure of the sensitive data, as the sensitive data may be processed in an unencrypted or ‘raw’ format. As a result, this may render commercially sensitive data vulnerable to attack.

In most circumstances, machine learning may not be performed on encrypted data. The reason for this is that machine learning and cryptographic encoding of data have opposing objectives. Machine learning is carried out by establishing patterns in data or other inputs, whereas cryptography aims to remove all patterns from its outputs. Therefore, depending on the type of encryption, machine learning may not be able to identify patterns in encrypted data.

The security of input data to, and output data from, a neural network or machine learning environment may be relevant. In some examples, a neural network may be implemented on different devices, such as data centres, general or specific purpose computers, edge servers or other edge devices, and processors with restricted function, such as accelerators.

Some computing systems may be subject to hacking or other forms of attack. Malware or rogue users may try to attack or access data going into a machine learning environment, for example to access the data or tamper with the integrity of the data. Even where specialized processors are used the general purpose OS may, currently, perform the data handling, controlling the data passed through to an accelerator. Thus, sensitive data may be under threat before (or after) being passed through the neural network.

In some examples, neural networks may be implemented on specialized processors designed to carry out a single, or a specific number of, functions. Accelerators may be one example of such a specialized processor. Such accelerators may, due to their restricted functionality, be inherently resistant to many forms of attack. However, the data being processed by an accelerator is input to and output from the accelerator, leading to a potential point in the processing of the data which is more susceptible to attack. A simplified processor, such as an accelerator, may have fewer vulnerabilities of the Spectre or Meltdown type.

A neural network may however, knowing an encryption key, or being programmed with the procedures for the encryption, be able to decrypt encrypted data, as part of the processing carried out therein or learn the cryptographic procedure used to encrypt the data. Therefore, in some examples, an encryption process or a decryption process may be carried out on an appropriately programmed neural network.

In order to allow a neural network to process encrypted data, the neural network may be divided into separate parts for dealing with the decryption/encryption of data and main processing of data, respectively.

In some examples, there is provided a system that may extend a machine learning model, such as a neural network, with layers dedicated to encryption/decryption (or any other cryptographic operations, e.g. signature, MAC). These layers may be concatenated to the layers that implement a main function of the model, such as pattern recognition or regression or prediction, for example.

In this way, the neural network includes separate layers dedicated to performing cryptographic functions, such as encryption and decryption, and the main function of the neural network. This arrangement may allow the neural network to process encrypted data. This data would then be unencrypted within the enclosure of the neural network environment but encrypted at both input and output.

In some examples, it may be useful to perform cryptographic operations, such as encryption/decryption, on the input but not the output, because the output may not include sensitive data or accessing the output in plaintext may not reveal any or enough information about the input to be of concern. In some examples, the input may be accessible, in plaintext, but the output may include sensitive information and thus may be encrypted.

Therefore, in accordance with some examples, in a machine learning environment, implemented on a neural network having a plurality of layers, layers may be included in the neural network for the purpose of data decryption. This may allow data to enter the neural network in an encrypted format and, once input into the neural network, the processing of the data within the neural network involves a distribution, transformation and/or fragmentation of the data, such that the data is inherently obscured from access. As such, the data is not readily accessible when being processed within the neural network, for example at the point of decryption.

Layers may further be included to perform cryptographic operations, such as encryption, on any data for output from the neural network, if the data to be output is sensitive in nature.

In accordance with some examples, the security of the data is improved by preventing the inputs to and outputs from a neural network from transiting in plaintext.

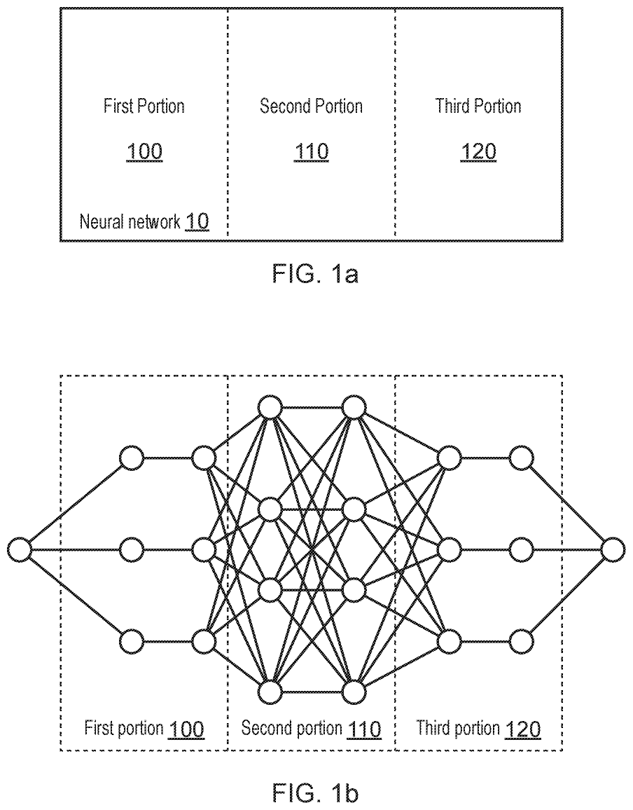

According to some examples, as described herein, and shown in FIG. 1a, there is provided a neural network 10. The neural network 10 may comprise a first portion 100. The first portion 100 may comprise a plurality of layers of the neural network 10 which may perform a first cryptographic operation on input data. The neural network 10 may further comprise a second portion 110. The second portion 110 may comprise a plurality of layers of the neural network 10 to perform processing on the data. The processing may be performed on the data after the first cryptographic operation is performed. The input data may be unencrypted/in plaintext format for the processing. The neural network 10 may further comprise a third portion 120. The third portion 120 may comprise a plurality of layers of the neural network 10 to perform a second cryptographic operation on the processed data.

FIG. 1b shows a simplified representation of the neural network structure of the neural network 10 shown in FIG. 1a. As shown, each portion may comprise a plurality of layers, each of which comprising a single node or a plurality of nodes. Within a neural network, each node of one layer may be connected to each node of the preceding and following layers. In the simplified representation of FIG. 1b, the connections between nodes are shown when the connection is active. Therefore, further connections may be present, but may not be shown as they are not considered active in this example.

Cryptographic operations may include for example encryption, decryption, signing, signature verification, MAC, authenticated encryption, etc.

Processing carried out on the unencrypted data, which may be referred to as the main function of the neural network, may include classification (images, malware), pattern recognition, and/or regression.

In some examples, the input data may be encrypted and the first cryptographic operation may be a decryption operation. In some examples, the processed data may be unencrypted and the second cryptographic operation may be an encryption operation.

In some examples the input data may come with a message authentication code (MAC) and the first cryptographic operations would be an MAC to validate the integrity of the input data. In some examples the second cryptographic operation would be to compute a MAC on the processed data.

In some examples, in accordance with the example shown in FIG. 1b, a first layer of nodes of the first portion 100 may receive encrypted input data. Within the nodes of the first portion 100, the encrypted input data may be decrypted, allowing the (unencrypted or plaintext) input data to be processed in the second portion 110. The decrypted input data may then be passed to the second portion 110, which may carry out the main function of the neural network 10, such as feature recognition or extraction from the input data. The processed data, or a result of the processing of the decrypted input data may then be passed to the third portion 120 for encryption. The third portion 120 may re-encrypt the received data using the same encryption technique used to encrypt the original input data or may encrypt the received data using a different encryption technique. The encrypted data may then be output from the neural network 10.

Neural networks may be structured so as to have multiple layers. Each layer may be programmed to carry out a specific operation or piece of processing on input data. Input data for each layer may be data received or output from a previous layer. For the first layer, the input data may be the raw input data.

The neural network 10 may be referred to as an artificial neural network (ANN) or as a deep learning neural network (DNN) or as a convolutional neural network (CNN).

In some examples, the first portion 100, the second portion 110 and the third portion 120 of the neural network 10 each, respectively, may each have a different architecture. The decryption performed in the first portion 100 may be different to the encryption performed in the third portion 120.

An architecture of a neural network or a portion of a neural network may be indicative of the processing performed by that portion, or may be indicative of how the data is to be processed or manipulated. Therefore, respective portions of the neural network 10 may have structures for performing decryption, another form of processing, such as pattern recognition for example, and encryption, respectively. The architecture of a neural network or of a portion of a neural network may include the structure of the nodes and interconnections therebetween as well as the functions carried out on those nodes.

In some examples, a set of weights of the plurality of layers of the first portion 100 may represent a decryption key to decrypt the encrypted input data.

A decryption key may be integrated into the layers of the first portion 100, such that, when input data, which is encrypted, is input into the neural network 10 at the first portion 100, the processing carried out in the layers of the first portion 100 results in the encrypted data being decrypted. This decryption process may be integrated into the weights of the first portion. In some examples, the decryption key may be provided along with the input data to the neural network.

In some examples, a set of weights of the plurality of layers of the third portion 120 may represent an encryption key to encrypt the processed data.

An encryption key may be integrated into the layers of the third portion 120, such that, when processed data, which is unencrypted, is input into the third portion 120 of the neural network 10, the processing carried out in the layers of the third portion 120 results in the unencrypted data being encrypted.

In accordance with some examples, there is disclosed a neural network having a modular architecture, where several models, each representing a given function may be concatenated to create a broader model. Some of these models may be dedicated to cryptographic operations while others may be dedicated to the intended main functionality of the model. Each model may be trained to work on the data expected to be output from the prior model (for example, the intended functionality model is expected to work on the decrypted data out of the decryption model). The cryptographic operations may be encryption/decryption as presented in the example above. The cryptographic operations may be based on symmetric cryptography or public-key cryptography may be used both for signatures and encryption/decryption.

In some examples, the neural network 10 is a modular neural network in which any of the first portion 100, second portion 110 and third portion 120 are substitutable.

In some examples, the first portion 100 may be structured or programmed with given cryptographic settings (e.g. a key for decrypting encrypted data in a given format). In examples in which the key is represented by the layers of the first portion, these layers may be changed to account for a new cryptographic environment (data encrypted using a different encryption method).

In these examples, the first portion 100 may be substituted for another first portion 100, providing a different decryption function, based on the input to the neural network and the method by which the data of the input is encrypted.

In some examples, the third portion 120 may be substituted for another third portion 120, providing a different encryption function, based on an intended form of encryption for the output.

Complexity/randomness of many encryption functions may lead to very different outputs for relatively similar inputs. This may lead to difficulty for a machine learning environment, such as a neural network, to learn patterns from example inputs and outputs of an encryption or decryption function. However, the individual procedures or actions in a cryptographic procedure, when separated out, may be relatively simple. These individual procedures may be learned or set manually and may then be aggregated to create a model of the encryption or decryption procedure with a given key. In some examples, the individual procedures may not depend on the key, and would therefore not have to be trained or set for every implementation of the cryptographic procedures with a different key; the procedures that depend on the key may be retrained or reset, or parametrized with the key. In some examples, the individual procedures may be known, but the weights, for example, not known. In this case, the weights may be derived to compute a given function.

Many encryption techniques use a series of procedures which, cumulatively, may prevent a neural network from identifying patterns and learning the encryption. However, when the procedures are separated out, these procedures may be implemented in the layers of the neural network, as they may follow predetermined patterns.

In some examples, the third portion 120 may encrypt the processed data according to Advanced Encryption Standard, AES, and respective layers of the third portion 120 may perform encryption procedures according to the AES. In some examples, the first portion 100 may decrypt the input data according to AES, and respective layers of the first portion 100 may perform decryption procedures according to AES.

The Advanced Encryption Standard (AES) is a standard for encrypting electronic data. When separated out into each separate function involved in AES, this standard may be implemented on a neural network. AES may include four main functions: ‘AddRoundKey’, ‘SubBytes’, ‘ShiftRows’ and ‘MixColumns’. Each of these functions may be performed using separate layers within a neural network. ‘SubBytes’, ‘ShiftRows’ and ‘MixColumns’ may in some examples be merged using lookup tables and XOR operations. An AES implementation may iterate though these functions multiple times and this may be achieved using a recurrent neural network structure or by unrolling the iterations with multiple modular neural network components.

The AddRoundKey may in essence be an exclusive-or (XOR) operation. This may be the operation where the key is combined using an XOR with the input data or the result of a previous iteration. A neural network may be trained to compute an XOR either on a bitwise basis or on a bytewise basis as with the SBox. In some examples, two bytes may be taken as input and a single byte as output and the neural network may be trained to compute the XOR. This may then be implemented on layers of the neural network. The ‘SubBytes’ function may in essence be a substitution box (SBOX). The SBOX, ShiftRows and MixColumns functions may in some examples be implemented together, using look-up tables. Such look-up tables may be referred to as a T-Box.

The ShiftRows function may be a simple permutation of bytes in 32-bit words. This reordering may be done with wires mapping a given byte from its old position to its new position. A neural network may be programmed to map an input to an output using a weight of 1 for one input and 0 for other inputs, for example. There may be multiple ways of carrying out such a substitution function; as a substitution box or as the inverse function over GF(2⁸). Both approaches may be implemented using a neural network.

The MixColumns function may perform a non-linear, bit-wise transformations of inputs, described in more detail below.

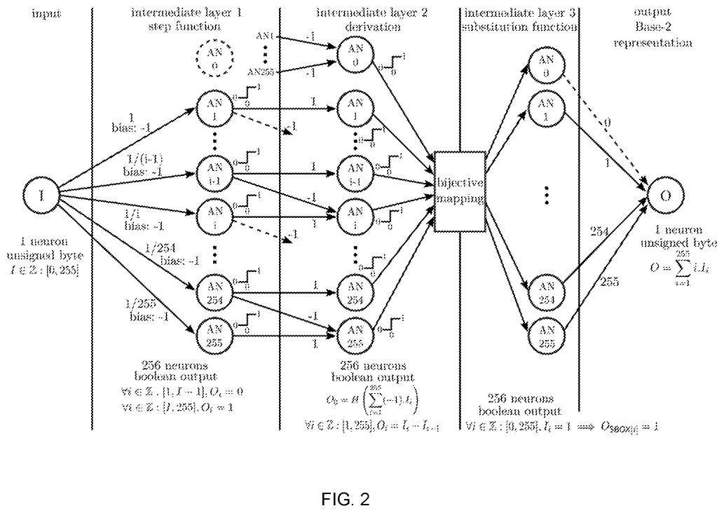

In some examples, a substitution box (SBOX) may be a bijective mapping from one byte of data to another byte of data. This may for example be implemented as shown in FIG. 2. A T-Box may be implemented in a similar manner to the example SBOX shown in FIG. 2.

Input neuron: the input neuron may be a byte representing an integer value between 0 and 255.

Intermediate layer 1 (step function): 256 neurons. The neuron at position i in layer 1 may be given a value based on the input neuron divided by its position in layer 1 (the synapse weight). Each neuron in this layer therefore may be given an input value that is above 1, below 1 or 1, that represents the input neuron's value relative to the neuron's position in layer 1. For example, if the input neuron has a value of 6 (in this case a randomly chosen number for demonstrative purposes), each neuron in layer 1 will be given the value 6/1, for the first neuron, 6/2, for the second, 6/3 . . . 6/6 (or 1) . . . up to 6/255, so that each neuron, but one, has a value lower or higher than 1 and a single neuron has a value of 1. A bias of −1 may be applied for the threshold to be 0. The activation function may be a Heavyside step function. Neuron 0 may in some examples be an exception: for example it may always be set at one. Therefore, it may not need to be represented in this layer as it may not provide any information.

Intermediate layer 2 (derivation): The neuron at position i in intermediate layer 2 may receive two inputs: the difference in value between the neurons i (weight 1) and i-1 (weight −1) in layer 1. Neuron 0 may be an exception: it may sum the inverse value (weight −1) of each of the neurons in layer 1. If any is activated, the value is negative, meaning that the value is superior to 0; otherwise, the value is 0, which means that the input was 0. One neuron should have a value of 1, the one at the position equivalent to the model's input neuron's value. The other neurons may have values of 0.

Intermediate layer 3 (substitution function): There is a bijective mapping between layers 2 and 3 that corresponds to the AES substitution function (that is usually represented using a lookup table—the AES SBOX). A layer 2 neuron's output maps directly to the input of one neuron of layer 3 (bijective mapping): the layer 2's neuron at position i maps to the layer 3's neuron at position SBOX[i]. One layer 3 neuron may be activated. The other neurons may not be activated.

Output (base-2 representation): reconstruction of the output's byte value in base-2 representation. The output neuron may have as inputs the value of each layer 3 neuron's outputs weighted by their position.

In some examples, a substitution box (SBOX) may be viewed as a look-up function from a value between 0 and 255 to a different value between 0 and 255. A standard neural network may be trained to learn this function using all examples from the lookup table during training.

In some examples, when calculating the inverse function over GF(2⁸), first the sub-operations to compute this inverse may be detailed.

The substitution function works with elements of the Galois Field GF(2⁸). There may be several ways to represent elements of this field. An approach with AES is to use the polynomial representation. A byte (b₇, b₆, . . . , b₀) may be represented as:

b_{7·}x⁷+b_{6·}x⁶+. . . +b₀

The multiplication of two elements in GF(2⁸) may include the multiplication of the two polynomial representations modulo an irreducible polynomial of degree 8 (which may already be set in the case of the AES), which may for example be referred to as m(x).

To find the multiplicative inverse of a univariate polynomial a(x) defined over a field, Bézout's identity may be used:

If g(x) is the GCD of two non-null polynomials a(x) and b(x), then there exist two polynomials u(x) and v(x) so that:

a(x). u(x)+b(x). v(x)=g(x)

To find the multiplicative inverse of a(x), Bézout's equation may be solved with b(x)=m(x) (the irreducible polynomial used as a modulo for multiplication). As m(x) may be irreducible and a(x) may necessarily be different from m(x), the GCD is 1. Bézout's identity becomes:

a(x).u(x)+m(x).v(x)=1

u(x) is the inverse of a(x) because a(x).u(x)≡1 (mod m(X)), i.e. u(x)=a⁻¹(x) mod m(x).

It may therefore be possible to solve Bézout's identity (i.e., to find u(x) and v(x)) using the extended GCD algorithm.

The extended GCD algorithm, may be computed using polynomial additions/subtractions, multiplications, and the computation of the quotient and remainder of two polynomials. The quotient and remainder of two polynomials can be computed using polynomial long division. This algorithm contains additions/subtractions and two coefficient division (for example, two Booleans equal to 1).

In summary, the inverse of an element a(x) over GF(2⁸) may be computed using the extended GCD algorithm which itself may use additions/subtractions/multiplications, and the polynomial long division. The latter may itself be implemented using additions/subtractions/multiplications. So the inverse may be implemented with additions/subtractions/multiplications, which are operations that may be implemented on a neural network.

A MixColumn operation may work on 32-bit words. They may be represented as four bytes each in GF(2⁸). A word may be represented from its four bytes in GF(2⁸) as:

a(x)=a_{3·}x³+a_{2·}x²+a_{1·}x+a₀

An addition with another word may be the addition of each of their terms, so overall as the XOR of each of their 32 bits.

Multiplication is a traditional polynomial multiplication, followed by modulo reduction with a polynomial of degree less than 4. For AES, this modulo polynomial is n(x)=x⁴+1. It may have an interesting property that: xⁱ mod (x⁴+1)=x^{i mod 4} This property may allow the multiplication of words a and b as:

$$( \begin{matrix}{c}_{0} \\ {c}_{1} \\ {c}_{2} \\ {c}_{3}\end{matrix} ) = ( \begin{matrix}{b}_{0} & {b}_{3} & {b}_{2} & {b}_{1} \\ {b}_{1} & {b}_{0} & {b}_{3} & {b}_{2} \\ {b}_{2} & {b}_{1} & {b}_{0} & {b}_{3} \\ {b}_{3} & {b}_{2} & {b}_{1} & {b}_{0}\end{matrix} ) \cdot ( \begin{matrix}{a}_{0} \\ {a}_{1} \\ {a}_{2} \\ {a}_{3}\end{matrix} )$$

The MixColumns function may be a multiplication of each of the four words within the 128-bit input by another polynomial. One of these four words may be represented by a polynomial a(x) defined over GF(2⁸) as above. It may be multiplied by the polynomial b(x)={03}x³+{01}x²+{01}x+{02} defined over GF(2⁸), and reduced modulo n(x)=x⁴+1. This multiplication may be reduced to the matrix multiplication:

$$( \begin{matrix}{c}_{0} \\ {c}_{1} \\ {c}_{2} \\ {c}_{3}\end{matrix} ) = ( \begin{matrix}02 & 03 & 01 & 01 \\ 01 & 02 & 03 & 01 \\ 01 & 01 & 02 & 03 \\ 03 & 01 & 01 & 02\end{matrix} ) \cdot ( \begin{matrix}{a}_{0} \\ {a}_{1} \\ {a}_{2} \\ {a}_{3}\end{matrix} )$$

This leads to multiplications and additions in GF(2⁸). These additions and multiplications in “GF” (2Λ8) may be described as basic arithmetic operations. Such basic arithmetic operations may be implemented on a neural network, for example, on layers or nodes of the neural network.

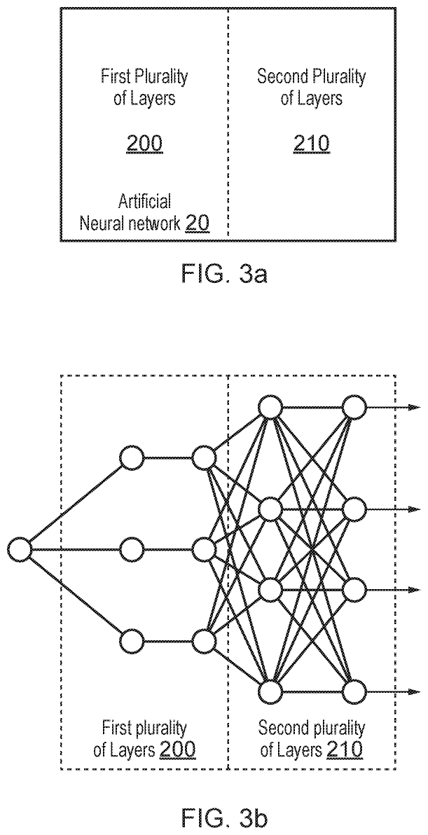

According to some examples, as described herein, and shown in FIG. 3a, there is provided an artificial neural network 20. The artificial neural network 20 may comprise a first plurality of layers 200 to convert ciphertext into plaintext. The artificial neural network 20 may further comprise a second plurality of layers 210 to perform processing on the plaintext.

The artificial neural network 20 may be divided into separate sections, each comprising layers and each layer comprising nodes. FIG. 3b shows a simplified representation of the neural network structure of the artificial neural network 20 shown in FIG. 3a. In some examples, the processing performed by the second plurality of layers 210 may include pattern identification in the plaintext.

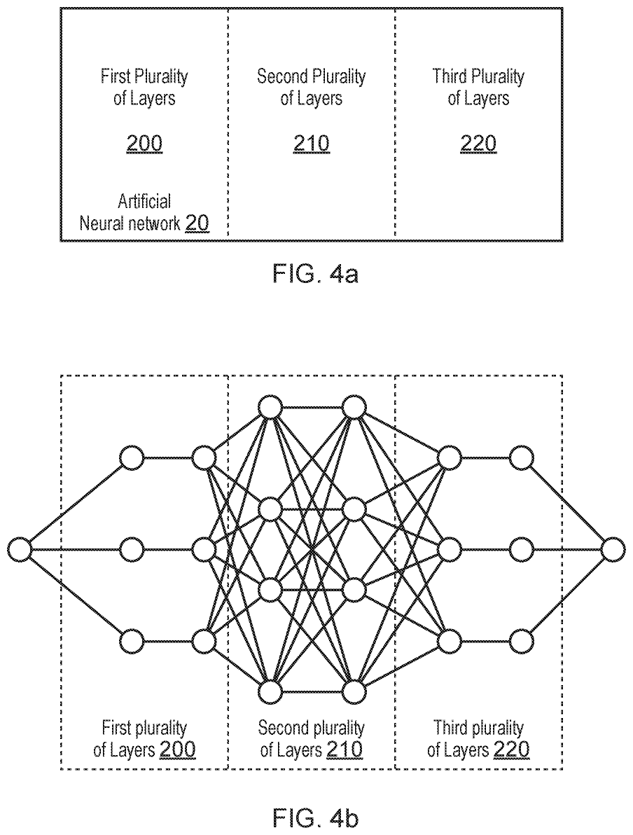

In some examples, as shown in FIG. 4a, the artificial neural network 20 may further comprise a third plurality of layers 220 to convert an output of the processing into ciphertext. FIG. 4b shows a simplified representation of the neural network structure of the artificial neural network 20 shown in FIG. 4a.

In some examples, a set of weights of the third plurality of layers 220 may represent a key to convert the output of the processing into ciphertext. An output of the processing may be output from the artificial neural network 20 as plaintext.

In some examples, the input to the artificial neural network 20 may be sensitive or confidential in nature. A key may be provided as the input, or part of the input to the neural network 20. However, the output may not necessarily be sensitive or confidential. In such circumstances, the output may be in plaintext format. A set of weights of the first plurality of layers 200 may represent a key to convert the ciphertext to plaintext.

In some examples, the third plurality of layers 220 may encrypt the processed data according to Advanced Encryption Standard, AES, and respective layers of the third plurality of layers 220 perform encryption procedures according to the AES. AES is described in detail above.

In some further examples there may be provided an artificial neural network comprising a first plurality of layers to perform processing on plaintext data. The artificial neural network may further comprise a second plurality of layers to convert the plaintext into ciphertext.

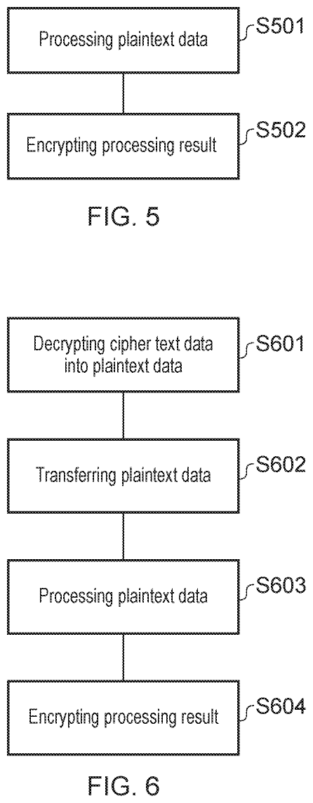

According to some examples, as described herein, and shown in FIG. 5, there is provided a method. The method may comprise performing processing S501 on plaintext data, in a processing part of a neural network. The method may further comprise encrypting S502 a result of the processing, in an encryption part of the neural network.

In some examples, as shown in FIG. 6, the method may further comprise decrypting S601 ciphertext data into plaintext data, in a decryption part of the neural network. The method may further comprise transferring S602 the plaintext data to the processing part of the neural network for processing. Method procedures S603 and S604 correspond to S501 and S502 of FIG. 5, respectively.

In some examples, the encrypting is performed according to Advanced Encryption Standard, AES, and respective layers of the neural network perform encryption procedures according to the AES.

In some examples, there may be provided a method comprising, decrypting encrypted data, in a decryption part of a neural network and performing processing on the decrypted, plaintext data, in a processing part of a neural network.

In accordance with some examples described above, processing carried out by a neural network may be performed on sensitive or confidential data, without the data being transmitted outside the neural network in plaintext format. Therefore, security may be improved and risks associating with transmitting the data reduced.

In some examples, a neural network as described above may be implemented on a specific-purpose computer processor, having separate processing resources dedicated to carrying out the decryption, encryption and main function, respectively. These resources may include a processor and a memory, for example. Physical connections between the processing resources may be configured so as to mirror, or be conductive to the function of, the connections of the neural network. For example, such a specific-purpose computer processor may be a systolic array/systolic engine.

Examples in the present disclosure can be provided as methods, systems or machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions may be made without departing from the scope of the present disclosure. It is intended, therefore, that the methods, devices and related aspects be limited only by the scope of the following claims and their equivalents. It should be noted that the above-mentioned examples illustrate rather than limit what is described herein, and that those skilled in the art will be able to design many alternative implementations without departing from the scope of the appended claims.

The word “comprising” does not exclude the presence of elements other than those listed in a claim, “a” or “an” does not exclude a plurality, and a single unit may fulfil the functions of several units recited in the claims.

The features of any dependent claim may be combined with the features of any of the independent claims or other dependent claims.

1. A neural network comprising:
a first portion, comprising a plurality of layers of the neural network, to perform a first cryptographic operation on input data;
a second portion, comprising a plurality of layers of the neural network, to perform processing on the data; and
a third portion, comprising a plurality of layers of the neural network, to perform a second cryptographic operation on the processed data.

2. The neural network of claim 1, wherein
the input data is encrypted and the first cryptographic operation is a decryption operation; and/or
the processed data is unencrypted and the second cryptographic operation is an encryption operation.

3. The neural network of claim 1, wherein
a set of weights of the plurality of layers of the first portion represents a decryption key to decrypt encrypted input data.

4. The neural network of claim 1, wherein
a set of weights of the plurality of layers of the third portion represents an encryption key to encrypt the processed data.

5. The neural network of claim 1, wherein
the neural network is a modular neural network in which any of the first portion, second portion and third portion are substitutable.

6. The neural network of claim 1, wherein
the third portion is to encrypt the processed data according to Advanced Encryption Standard, AES, and
respective layers of the third portion are to perform encryption procedures according to the AES.

7. An artificial neural network comprising:
a first plurality of layers to convert ciphertext into plaintext; and
a second plurality of layers to perform processing on the plaintext.

8. The artificial neural network of claim 7, further comprising:
a third plurality of layers to convert an output of the processing into ciphertext.

9. The artificial neural network of claim 8, wherein
a set of weights of the third plurality of layers represents a key to convert the output of the processing into ciphertext.

10. The artificial neural network of claim 7, wherein
an output of the processing is output from the artificial neural network as plaintext.

11. The artificial neural network of claim 7, wherein
a set of weights of the first plurality of layers represents a key to convert the ciphertext to plaintext.

12. The artificial neural network of claim 8, wherein
the third plurality of layers is to encrypt the processed data according to Advanced Encryption Standard, AES, and
respective layers of the third plurality of layers are to perform encryption procedures according to the AES.

13. A method comprising:
performing processing on plaintext data, in a processing part of a neural network; and
encrypting a result of the processing, in an encryption part of the neural network.

14. The method of claim 13, further comprising
decrypting ciphertext data into plaintext data, in a decryption part of the neural network; and
transferring the plaintext data to the processing part of the neural network for processing.

15. The method of claim 13, wherein
the encrypting is performed according to Advanced Encryption Standard, AES, and
respective layers of the neural network perform encryption procedures according to the AES.
